(19) United States
(12) Patent Application Publication
(10) Pub. No.: US 2003/0014657 A1
(43) Pub. Date: Jan. 16, 2003

(54) Auto online mechanism and method

(76) Inventors: Gary Kuan-Hong Hsieh, Taipei (TW); Chen-Yuan Lo, Taipei (TW)

Correspondence Address: RABIN & CHAMPAGNE, P.C., Suite 500, 1101 14 Street, N.W., Washington, DC, 20005, US

(21) Appl. No.: 09/902,662

(22) Filed: Jul. 12, 2001

(51) Int. Cl. G06F 11/30

(52) U.S. Cl. 713/200

(57) ABSTRACT

A mechanism and method to connect to Internet automatically providing at least one card in which there is pre-stored corresponding data to automatically log on predefined target website and open the web page in Internet Explorer. There is also a card reader can hold inserted card and can automatically output the data read from the inserted card. A microcomputer-processing device that has a permanent program, which can display web page of Internet Explorer. When the card is inserted to card reader, it can automatically log on predefined target website and open the web page in Internet Explorer. The permanent program can automatically check at fixed intervals whether the card is still in the card reader. When the data of the card is still being output in a predefined time, the system will retain online mode. Otherwise, if the data of the card ceases to be output in a predefined time, the system will change to offline mode immediately.

### FIELD OF INVENTION

The present invention relates to an online mechanism and method, especially the auto online mechanism and method that needs no operation of mouse or keyboard.

### BACKGROUND OF INVENTION

Although it is getting more and more popular to surf on the Internet via personal computer, it is still very difficult to some people, especially to the old aged people or those who cannot use computer often.

The major reason for this is because if a person wants to surf on the Internet via personal computer, he needs to know how to boot computer, connect to the Internet via MODEM and then click Internet Explorer or Netscape or other similar windows software and then he has to know how to select a preferred website. If there is any mistake in these continual procedures, the user cannot connect to the Internet correctly and it is too complicated and costs long time. For those paid website, the user has to remember username and password and know how to input the correct data to log on the website.

Besides, some people cannot always use only one specific computer, they may often use others' computers, then he has to repeat the above-mentioned procedures to boot computer, connect to the Internet via MODEM, click a windows software with mouse, which is very complicated and requires long time. Therefore, the traditional online mechanism and method via PC needs improvement and breakthrough.

### SUMMARY OF INVENTION

The object of the present invention is to provide a most convenient auto online mechanism, card and method that need no operation of mouse or keyboard. Furthermore, the present invention can also provide an auto online mechanism and method that enables user to charge according to actual online time.

The method of the present invention's auto online upon card insertion provides first at least one card in which there has pre-stored data to automatically locate target UNIFORM RESOURCE LOCATOR(abbr. URL) and open the web page. There has also stored a succession of passwords belonging exclusively to the card. Meanwhile, the present invention provides at least one card reader that has a card reading device inside to hold inserted card and can automatically output the data read from the card. Furthermore, the present invention also provides at least one microcomputer-processing device connected to the card reader that can display web page of the browser and in which there has installed a standing program. After the card is inserted into the card reader, it can automatically locate target URL and open the web page.

With the standing program installed in the microcomputer-processing device, the present invention can automatically check intermittently whether the card is still in the card reading device. If the data of the card is output in a predefined time, it will maintain online mode. Contrarily, if the data of the card is not output in a predefined time, it will cut offline immediately. A preferred embodiment is that inside the microcomputer-processing device there has also stored a standing program to automatically open the browser.

A preferred embodiment to enhance confidentiality requires the present invention to provide a manual password input device and requires user to input a succession of passwords belonging exclusively to the card to check in after the card is inserted.

The card for the present invention's auto online upon card insertion mechanism is characterized in that in the card there has stored data to automatically locate target URL and open web page. The mechanism embodied according to the present invention's auto online upon card insertion method comprises: at least one card, at least one card reader to provide a card-reading position after the card is inserted in, and at least one microcomputer-processing device connected to the card reader that can display web page of the browser.

The card reader of the present mechanism comprises: a device to hold card and can output data read from the card. The microcomputer-processing device has at least one data-processing unit that has a standing program to execute signal to check and judge the working status of the card reader intermittently at fixed intervals. A preferred embodiment of the standing program is to comprise also a driver to automatically open or close the browser. The mechanism of the present invention can also comprise a manual password input device for user to input a succession of passwords belonging exclusively to the card for double authorization.

The present invention can also manufacture a combined card-reading unit different from traditional card reader that has a card-reading unit for card to enter card-reading position and output data read from the card automatically. And it is characterized in that the card reader comprises a microcomputer-processing device that has at least one standing program to execute signal to check and judge the working status of the card reader intermittently at fixed intervals. The standing program also comprises a driver to automatically open or close the browser. The combined card-reading unit of the present invention can also comprise a manual password input device.

Furthermore, this invention can also manufacture a microcomputer-processing device and interface unit that is used for auto online upon card insertion mechanism. In the microcomputer-processing device there has a data-processing unit that has a standing program and at least one interface to be connected to card reader and the Internet respectively. The standing program in the microcomputer-processing device can execute signal to check and judge the working status of the card reader intermittently at fixed intervals and driver to automatically open or close the browser.

### BRIEF DESCRIPTION OF DRAWINGS

The attached figures illustrate the preferred embodiment of this auto online mechanism and method of the present invention.

FIG. 1 is flow chart of this auto online mechanism and method.

FIG. 2 is flow chart of auto detecting and control after connecting to the Internet via this auto online mechanism.

FIG. 3 is system schematic of this auto online mechanism.

FIG. 4 is schematic of the card employed in this auto online mechanism.

FIG. 5 is schematic of the embodiment of the card-reading device employed in this auto online mechanism.

FIG. 6 is schematic of the embodiment of the micro processing interface unit employed in this auto online mechanism.

### DETAILED DESCRIPTION OF THE PREFERRED EMBODIMENT

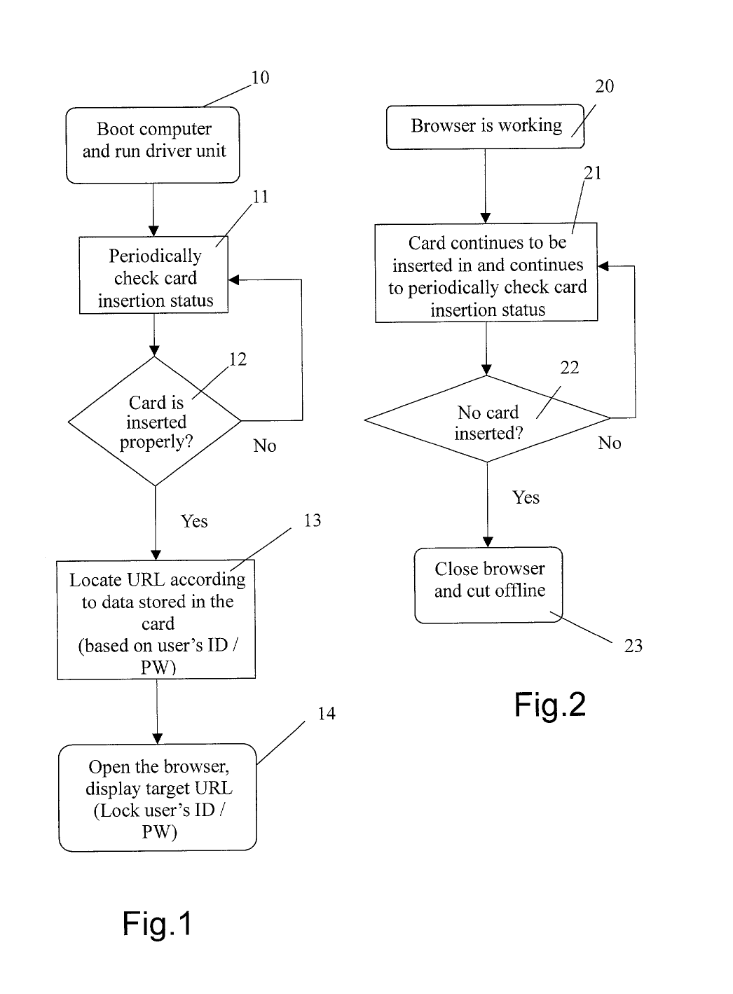

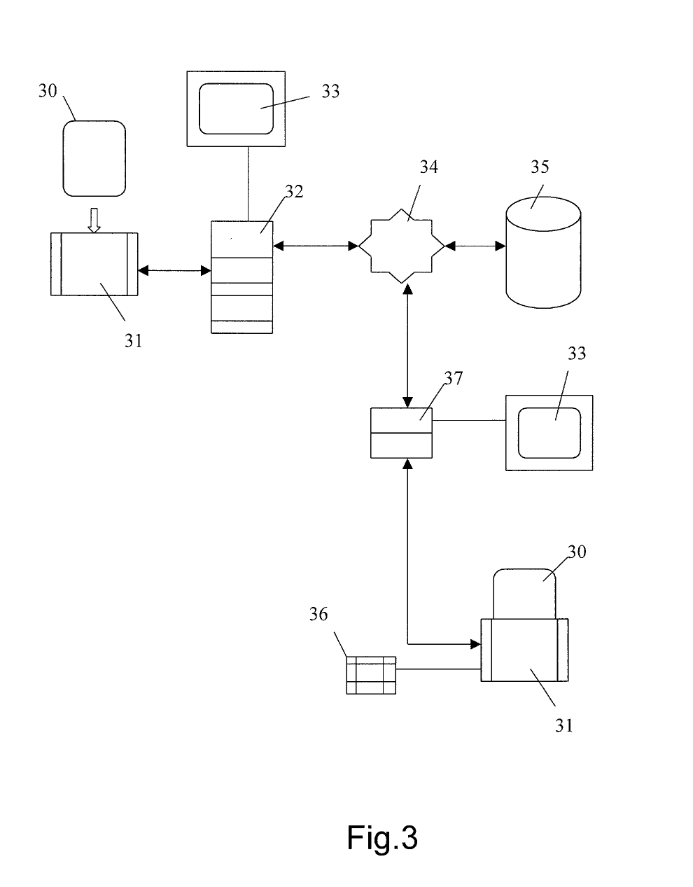

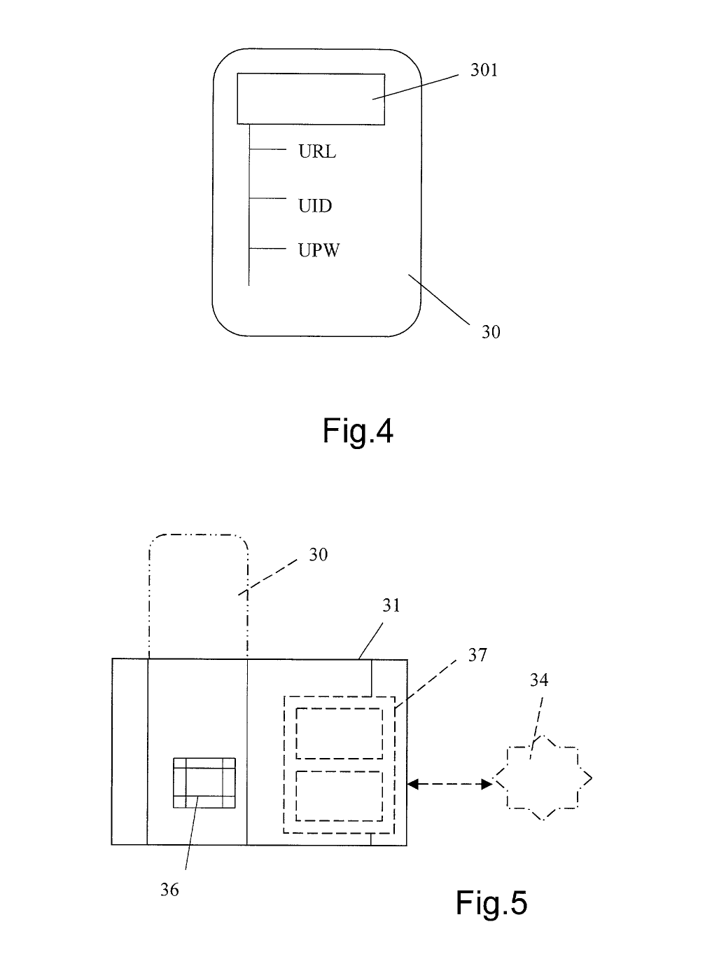

As illustrated in FIG. 4 and please refer to FIG. 1, the card (30) used for this auto online upon card insertion mechanism is characterized in that the chip (301) in the card (30) has data to automatically locate target URL, furthermore, it contains data to open the web page. Besides, it also comprises user's ID (UID) and password (UPW). The auto online method of the present invention provides at least an above-mentioned card (30) and at least a card reader (31), refer to FIG. 3, whose card-reading device can hold the card (30) inside and can automatically output data read from the card (30).

The card reader (31) reads out the data to locate target URL stored in the card (30) and outputs automatically, and then as illustrated in FIG. 1, it executes the program to boot computer and run driver (block 10). When the card (31) is inserted properly and outputs signals, it can periodically check via the standing program in the microcomputer-processing device card insertion status (block 11) and check whether the card (31) is inserted in the proper position and outputs signals (block 12). If the card is not inserted properly, it will remind user to check or re-insert and then repeat the above-mentioned procedures of block 11. Contrarily, if the card (31) is inserted properly, it will locate URL (block 13) according to data of the card (31), e.g. a smart card. Of course the program can execute according to user's ID and/or password and further locate target URL and open the browser (block 14) and then lock user's ID/password and therefore make it possible if needs to charge.

As illustrated in FIG. 2, when the browser is open and working (block 20), the card (31) continues to be inserted in the card reader (31) and periodically check via the standing program in the microcomputer-processing device card insertion status (block 21) and check whether there is no card inserted (block 22). If there is inserted card, it will maintain surveillance mode. Once the card is drawn out, it will judge there is no inserted card and close the browser and cut offline immediately (block 23).

As illustrated in FIG. 3, the auto online upon card insertion mechanism of the present invention comprises: at least one card (30) that has above-mentioned characteristics; at least one card reader (31) to hold the card (30) in the card-reading position; and at least a microcomputer-processing device that can display web page of the browser (33). The microcomputer-processing device has a mechanism to automatically locate target URL and a mechanism to periodically check card insertion status and a driver mechanism to automatically open or close the browser. The microcomputer-processing device can make use of personal computer (32) or pony sized special microcomputer processor (37) to connect to card reader (31) and the Internet (34) and further connect to main server (35) that provides data of target URL. A preferred embodiment of the mechanism can also comprise a manual password input device (36) for user to input a succession of passwords belonging exclusively to the card (30) to microcomputer-processing device for double authorization.

The present invention can manufacture as illustrated in FIG. 5 a combined unit of card reader (31) connected to the Internet (34). The combined unit of card reader (31) has a card-reading unit for card (30) to enter card-reading position and output data automatically read from the card. It is characterized in that the combined unit of card reader (31) also comprises a microcomputer processor (37) that has a mechanism to automatically locate target URL and has at least one standing program that can execute signal to check and judge the working status of the card-reading unit intermittently at fixed intervals as mentioned above. The standing program can also comprise a driver data to automatically open or close the browser. The combined unit of card reader (31) can also integrate an above- mentioned manual password input device (36).

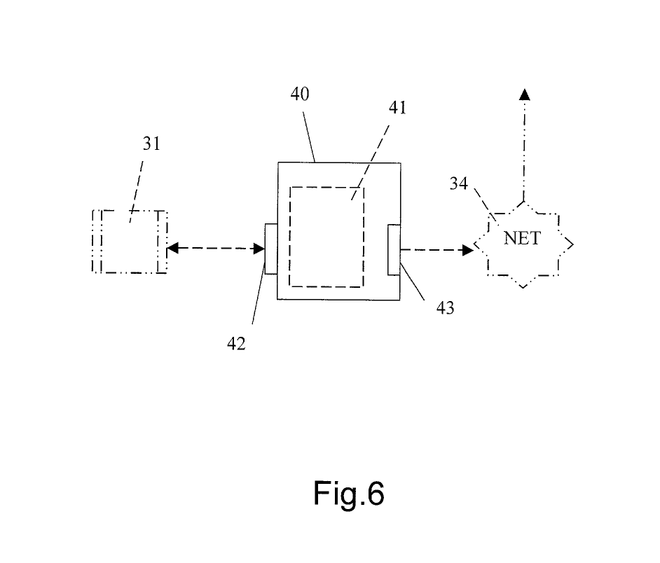

Furthermore, as illustrated in FIG. 6, the present invention can also manufacture a microcomputer-processing device and interface unit (40) for this auto online upon card insertion mechanism. Inside the microcomputer-processing device there has a mechanism to automatically locate target URL, a data processing unit (41) with a standing program and at least one interface unit, e.g., the first interface (42) connected to card reader (31) and the second interface (43) connected to the Internet (34). The standing program comprises a signal to execute checking and judging of the working status of the card reader intermittently at fixed intervals and the driver data to automatically open or close the browser.

The present invention provides a most convenient auto online mechanism that needs no operation of mouse or keyboard. The erasable data stored in smart card enables user to directly open browser and locate target URL once the card is inserted. The affiliated function of the present invention can use smart card to record transaction and charge according to user's actual online time.

The above-mentioned embodiments give evidence of the operability of this invention in details. However, if anyone masters this technology and invents a similar system that has difference either in appearance or in details, will be held legal responsibility of trespassing the originality and patent of this invention. Although certain preferred embodiment of the present invention has been shown and described in detail, it should be understood that various changes and modification might be made therein without departing from the scope of the appended claims.

What is claimed is:

1. An auto online upon card insertion mechanism comprising:
a card, in which has stored accessible data that comprises data to automatically locate target UNIFORM RESOURCE LOCATOR and open the web page;
a card reader, for said card to enter card-reading position of said card reader, comprising a device to hold card and can output data read from said card; and
a microcomputer-processing device, for display web page of the browser, said microcomputer-processing device connected to said card reader and has at least a data processing unit with a standing program that can execute signal to check and judge the working status of said card reader intermittently at fixed intervals.

2. The auto online upon card insertion mechanism of claim 1, further comprising a manual password input device for user to input a succession of passwords belonging exclusively to said card to said microcomputer-processing device.

3. The auto online upon card insertion mechanism of claim 1, wherein the standing program of said microcomputer-processing device also comprises driver data to automatically open the browser.

4. A card for auto online upon card insertion mechanism, that is characterized in that in said card there is stored data to automatically locate target UNIFORM RESOURCE LOCATOR and open the web page.

5. A card reader that has a card-reading unit for a card to enter card-reading position and output data automatically read from the card; said card reader comprises a microcomputer-processing device that has at least a data processing unit with standing program that can execute signal to check and judge the working status of said card reader intermittently at fixed intervals.

6. The card reader of claim 5, further comprising a manual password input device for user to input a succession of passwords belonging exclusively to the card to said microcomputer-processing device.

7. The card reader of claim 5, wherein the standing program in said microcomputer-processing device also comprises driver data to automatically open browser.

8. A microcomputer-processing device and interface means for auto online upon card insertion mechanism, that has a data processing unit; and at least an interface to be connected to card reader and the Internet respectively; and said data processing unit has standing program that can execute signal to check and judge the working status of the card reader intermittently at fixed intervals.

9. The microcomputer-processing device and interface means of claim 8, wherein said standing program also comprises driver data to automatically open the browser.

10. An auto online upon card insertion method, comprising:
providing at least a card and pre-storing data to automatically locate target UNIFORM RESOURCE LOCATOR in the card;
providing at least a card reader that can read data of inserted card and output automatically;
providing at least a microcomputer-processing device connected to the card reader that can display the web page of the browser;
installing a standing program in said microcomputer-processing device;
checking periodically with standing program whether the card is still in the card-reading device and maintaining online mode if the data corresponding to the card is still being output in a predefined time.

11. The auto online upon card insertion method of claim 10, further comprising: providing a manual password input device and requiring user to input a succession of passwords belonging exclusively to said card.

12. The auto online upon card insertion method of claim 10, further comprising cutting offline if the data corresponding to the card is not output in a predefined time

13. The auto online upon card insertion method of claim 10, further comprising: storing data to automatically open the browser in the standing program of said microcomputer-processing device.

14. The auto online upon card insertion method of claim 10, further comprising: pre-storing in the card a succession of passwords belonging exclusively to said card.
